(19) United States
(12) Patent Application Publication
(10) Pub. No.: US 2005/0078345 A1
(43) Pub. Date: Apr. 14, 2005

(54) Scanning device with improved magnetic drive

(76) Inventors: Arthur Monroe Turner, Allen, TX (US); Andrew Steven Dewa, Plano, TX (US); John W. Orcutt, Richardson, TX (US); Mark W. Heaton, Irving, TX (US)

Correspondence Address: TEXAS INSTRUMENTS INCORPORATED, P O BOX 655474, M/S 3999, DALLAS, TX, 75265, US

(21) Appl. No.: 10/682,583

(22) Filed: Oct. 9, 2003

(51) Int. Cl. G02B 26/08

(52) U.S. Cl. 359/224; 359/296

(57) ABSTRACT

A magnetic drive for providing pivotal motion to a mirror device. The magnetic drive may be used to drive any torsional hinged mirror, but is particularly suitable for driving a high-speed, torsional hinged mirror at its resonant frequency for use as the drive engine of a printer or visual display. According to a first embodiment, a dual axis mirror uses a first pair of torsional hinges to provide the resonant beam sweep and a second pair of torsional hinges to provide high-speed movement orthogonal to the beam sweep to maintain successive images of the sweep parallel to each other. The mass and movement of inertia of the resonant mirror are reduced by relocating permanent magnet sets to the axis of rotation. The reduced mass and movement of inertia allows a significantly higher resonant frequency and corresponding high pivotal speed.

### CROSS-REFERENCE TO RELATED APPLICATIONS

This application relates to co-pending and commonly assigned patent application Ser. No. ______, entitled “Pivoting Mirror with Improved Magnetic Drive,” (Attorney Docket No. TI-36488) filed concurrently herewith, which application is hereby incorporated herein by reference.

### TECHNICAL FIELD

The present invention relates generally to scanning devices that incorporate a functional surface, such as a mirror, and more specifically to a magnetically driven MEMS (micro-electric mechanical systems) torsional hinge scanning device. The invention is particularly suitable for use with scanning devices, such as mirrors, having an improved resonance frequency to provide bi-directional raster type scanning. When the scanning device is a mirror, a light beam may be moved across a photosensitive medium for printing, or to provide a visual display. According to one embodiment of this application, a first set of torsional hinges provides a rapidly pivoting mirror for generating a rapid back and forth beam sweep at a controlled frequency, and preferably a resonant frequency, about a first axis, such as a raster scan. A second pair of torsional hinges may be provided for movement about a second axis to control movement in a direction substantially orthogonal to the bi-directional movement. These rapidly oscillating functional surfaces may be used for any suitable application, but if the functional surface is a mirror, they are particularly suited for use as the drive engine for a laser printer and to provide the raster scanning motion for generating a display on a screen.

### BACKGROUND

Rotating polygon scanning mirrors are typically used in laser printers to provide a “raster” scan of the image of a laser light source across a moving photosensitive medium, such as a rotating drum. Such a system requires that the rotation of the photosensitive drum and the rotating polygon mirror be synchronized so that the beam of light (laser beam) sweeps or scans across the rotating drum in one direction as a facet of the polygon mirror rotates past the laser beam. The next facet of the rotating polygon mirror generates a similar scan or sweep which also traverses the rotating photosensitive drum but provides an image line that is spaced or displaced from the previous image line.

There have also been prior art efforts to use a less expensive flat mirror with a single reflective surface, such as a resonant mirror, to provide a scanning beam. For example, a dual axis or single axis scanning mirror may be used to generate the beam sweep or scan instead of a rotating polygon mirror. The rotating photosensitive drum and the scanning mirror are synchronized as the “resonant” mirror first pivots or rotates in one direction to produce a printed image line on the medium that is at right angles or orthogonal with the movement of the photosensitive medium.

However, the return sweep will traverse a trajectory on the moving photosensitive drum that is at an angle with the printed image line resulting from the previous sweep. Consequently, use of a single reflecting surface resonant mirror, according to the prior art, required that the modulation of the reflected light beam be interrupted as the mirror completed the return sweep or cycle, and then again start scanning in the original direction. Using only one of the sweep directions of the mirror, of course, reduces the print speed. Therefore, to effectively use an inexpensive resonant mirror to provide bi-directional printing, the prior art required that the mirror surface be continuously adjusted in a direction perpendicular to the scan such that the resonant sweep of the mirror in each direction generates images on a moving or rotating photosensitive drum that are always parallel. This continuous perpendicular adjustment may be accomplished by the use of a dual axis torsional mirror or a pair of single axis torsional mirrors. As has been discussed, however, at today's high print speeds both forward and reverse sweeps of a single axis mirror may be used.

Texas Instruments presently manufactures torsional dual axis and single axis resonant mirror MEMS device fabricated out of a single piece of material (such as silicon, for example) typically having a thickness of about 100-115 microns. The dual axis layout consists of a mirror normally supported on a gimbal frame by two silicon torsional hinges, whereas for a single axis mirror the mirror is supported directly by a pair of torsional hinges. The reflective surface may be of any desired shape, although an elliptical shape having a long axis of about 4.0 millimeters and a short axis of about 1.5 millimeters is particularly useful. The elongated ellipse-shaped mirror is matched to the shape that the angle of the beam is received. The gimbal frame used by the dual axis mirror is attached to a support frame by another set of torsional hinges. These mirrors manufactured by Texas Instruments are particularly suitable for use with a laser printer. One example of a dual axis torsional hinged mirror is disclosed in U.S. Pat. No. 6,295,154 entitled “Optical Switching Apparatus” and was assigned to the same assignee on the present invention.

According to the prior art, torsional hinge mirrors were initially driven directly by magnetic coils interacting with small magnets mounted on the pivoting mirror at a location orthogonal to and away from the pivoting axis to oscillate the mirror or create the sweeping movement of the beam. In a similar manner, orthogonal movement of the beam sweep was also controlled by magnetic coils interacting with magnets mounted on the gimbals frame at a location orthogonal to the axis used to pivot the gimbals frame.

According to the earlier prior art, the magnetic coils controlling the mirror or reflective surface portion typically received an alternating positive and negative signal at a frequency suitable for oscillating the mirror at the desired rate. Little or no consideration was given to the resonant pivoting frequency of the mirror. Consequently, depending on the desired oscillating frequency or rate and the natural resonant frequency of the mirror about the pair of torsional hinges, significant energy could be required to pivot the mirror. This increase in energy may be significant if it is necessary to maintain the mirror in a state of oscillation. Furthermore, the magnets mounted on the mirror portion added mass and limited the oscillating speed.

Later torsional mirrors were manufactured to have a specific resonant frequency substantially equivalent to the desired oscillation rate. Various inertially coupled drive techniques including the use of piezoelectric devices and electrostatic devices have been used to initiate and keep the mirror oscillations at the resonant frequency. Unfortunately, these new techniques have their own problems when used to maintain resonance of the mirror.

The earlier inexpensive and dependable magnetic drive could also be used to set up and maintain the pivoting mirror at its resonant frequency. Unfortunately, the added mass of the magnets becomes more and more of a problem as the required resonant frequency increases to meet the higher and higher printing speed demands.

Therefore, a dependable and inexpensive drive mechanism to create and maintain a high resonant frequency in a torsional mirror would be advantageous.

### SUMMARY OF THE INVENTION

The problems mentioned above are addressed by the present invention, which, according to one embodiment, provides a magnetic drive apparatus suitable for use as the means for rapidly pivoting a functional surface, such as a mirror, back and forth. If the functional surface is a mirror, the mirror may be used for sweeping or scanning a beam of light across a photosensitive medium. The apparatus comprises a functional surface portion that oscillates back and forth at a selected frequency and preferably at a resonant frequency. When the functional surface is a mirror, it is positioned to intercept the beam of light from a light source and reflects the scanning light beam to the photosensitive medium. A support structure supports the functional surface or mirror device along a first pair of torsional hinges, for pivoting around a first axis.

According to a single axis embodiment, the support structure comprises a support member connected directly to the reflective surface by the first pair of torsional hinges. Alternately, according to a dual axis embodiment, the support structure includes a second pair of torsional hinges extending between the support member and a gimbals portion arranged to allow the gimbals portion to pivot about a second axis substantially orthogonal to the first axis. The functional surface portion, such as a mirror, is attached to the gimbals portion by the first pair of torsional hinges. When the functional surface is a mirror positioned to intercept a beam of light, pivoting of the device along the first axis and about the first pair of torsional hinges results in the beam of light reflected from the mirror or reflective surface sweeping back and forth, and pivoting of the device about the second pair of torsional hinges results in the reflected light moving substantially orthogonal to the sweeping beam of light. If the functional surface is not a mirror or reflective surface, the two pair of torsional hinges allow movement of the functional surface about the axis. In both the single axis and dual axis embodiments, at least one magnet is mounted along the first axis and, if two magnets are used, one each of the magnets is located adjacent one of the hinges of the first pair of torsional hinges. One technique for magnetically driving the pivoting motion of the device is to attach a magnet selected to have a diametral charge perpendicular to the axis of rotation and substantially parallel to the functional surface or mirror. A first magnetic driver is located below the first magnet and cooperates with the magnet(s) to cause pivotal oscillations, and preferably resonant pivoting, about the first pair of torsional hinges. Another technique provides for attaching the magnets to the mirror such that the “N”-“S” pole orientation is perpendicular to the reflecting surface of the mirror such that a pair of electromagnetic arms that switch polarity cooperate with one of the “N” or “S” poles of the magnet to cause the pivotal motion.

According to the dual axis embodiment, there is also included at least another two magnets mounted along the second axis such that one each of the second magnets is located adjacent one hinge of the second pair of torsional hinges. A second magnetic driver is located below and cooperates with the two second magnets according to either of the two techniques discussed above to pivot the device about the second pair of torsional hinges. When the functional surface is a mirror, the second set of torsional hinges provides an orthogonal component to the beam sweep.

### BRIEF DESCRIPTION OF THE DRAWINGS

Other objects and advantages of the invention will become apparent upon reading the following detailed description and upon referencing the accompanying drawings in which:

FIGS. 1A, 1B, and 1C illustrate the use of a rotating polygon mirror for generating the sweep of a laser printer according to the prior art;

FIG. 2 is an embodiment of a functional surface, such as a mirror, supported by a single pair of torsional hinges;

FIGS. 3A, 3B, 3C, and 3D illustrate a prior art example of using a single axis flat mirror to generate a unidirectional beam sweep of a laser printer;

FIGS. 4A-4B are cross-sectional views of FIG. 2 illustrating one method of providing magnetic rotation or pivoting of a functional surface, such as a mirror, about the torsional hinge;

FIG. 5 is a perspective illustration of the single axis mirror of FIG. 2 to generate a resonant beam sweep such as used with a laser printer;

FIG. 6 is a perspective view of a prior art two-axis torsional hinge device (such as a mirror) for providing orthogonal movement;

FIGS. 7A, 7B, and 7C illustrate the use of a single two-axis resonant mirror such as shown in FIG. 6 to generate a bi-directional beam sweep of a laser;

FIGS. 8A-8D are cross-sectional views of the device of FIG. 6 illustrating one method of providing magnetic rotation or pivoting about the two sets of torsional hinges;

FIG. 9 is a perspective illustration of the use of a dual axis mirror of the type shown in FIG. 6 to generate a rapid beam movement in a first direction and in a second direction orthogonal to the first direction including a bi-directional beam sweep of a laser printer and an optical switch;

FIGS. 10A and 10B illustrate a prior art magnetic coil drive arrangement used to create an oscillating laser beam sweep;

FIGS. 11A and 11B illustrate a magnetic drive technique for providing resonant pivoting according to one embodiment of the invention;

FIGS. 12A and 12B illustrate a prior art magnetic coil drive arrangement to provide orthogonal movement;

FIGS. 13A and 13B illustrate a magnetic drive arrangement for providing orthogonal movement according to another embodiment of the invention; and

FIGS. 14A and 14B illustrate an alternate magnetic drive techniques according to the present invention suitable for use with the embodiments discussed with respect to FIGS. 11A and 11B and 13A and 13B.

### DETAILED DESCRIPTION OF ILLUSTRATIVE EMBODIMENTS

Like reference numbers in the figures are used herein to designate like elements throughout the various views of the present invention. The figures are not intended to be drawn to scale and in some instances, for illustrative purposes, the drawings may intentionally not be to scale. One of ordinary skill in the art will appreciate the many possible applications and variations of the present invention based on the following examples of possible embodiments of the present invention. The present invention relates to a pivoting apparatus with a moveable functional surface. More specifically, the invention relates to a functional surface, such as a mirror structure, and magnetic drive for pivoting the functional surface about an axis, including maintaining high-speed resonant oscillation of the functional surface about a pair of torsional hinges.

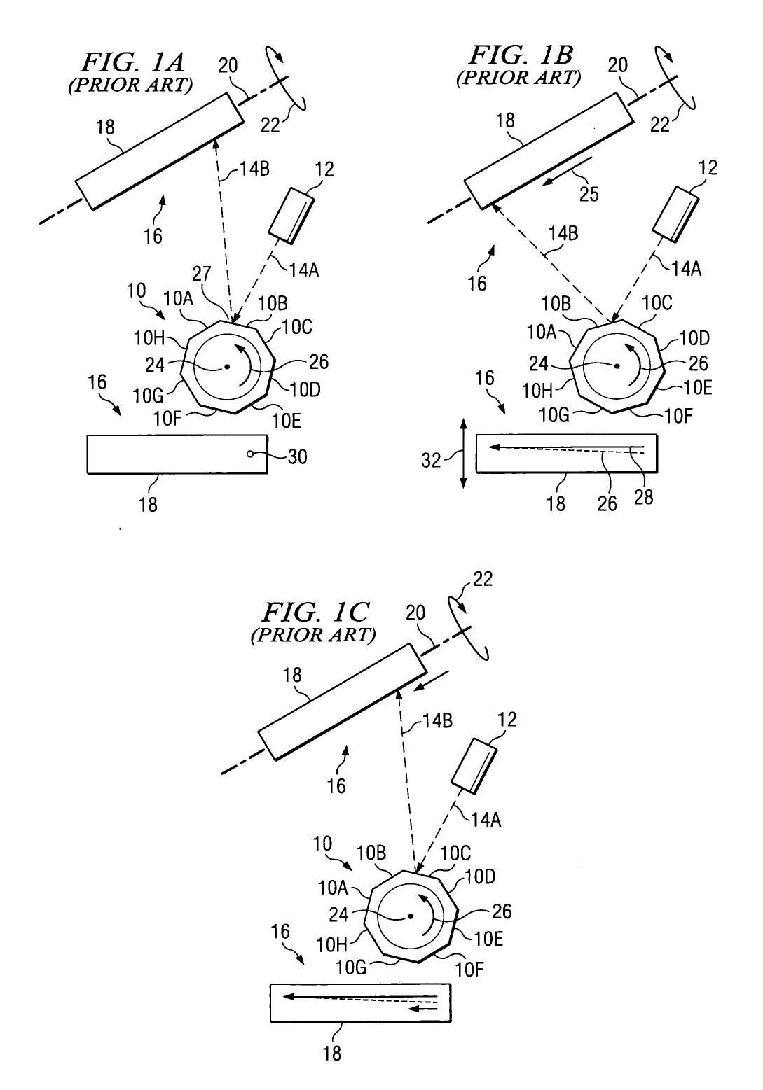

Referring now to FIGS. 1A, 1B and 1C, there is shown an illustration of the operation of a prior art printer engine using a rotating polygon mirror. As shown in FIG. 1A, there is a rotating polygon mirror 10 which in the illustration has eight reflective surfaces 10A-10H. A light source 12 produces a beam of light, such as a laser beam, that is focused on the rotating polygon mirror so that the beam of light from the light source 12 is intercepted by the facets 10A-10H of rotating polygon mirror 10. Thus, the laser beam of light 14A from the light source 12 is reflected from the facets 10A-10H of the polygon mirror 10 as illustrated by dashed line 14B to a moving photosensitive medium 16 such as a rotating photosensitive drum 18 having an axis of rotation 20. The moving photosensitive medium 16 or drum 18 rotates around axis 20 in a direction as indicated by the arcurate arrow 22 such that the area of the moving photosensitive medium 16 or drum 18 exposed to the light beam 14B is continuously changing. As shown in FIG. 1A, the polygon mirror 10 is also rotating about an axis 24 (axis is perpendicular to the drawing in this view) as indicated by the second arcurate arrow 26. Thus, it can be seen that the leading edge 27 of facet 10B of rotating polygon mirror 10 will be the first part of facet 10B to intercept the laser beam of light 14A from the light source 12. As the mirror 10 rotates, each of the eight facets of mirror 10 will intercept the light beam 14A in turn. As will be appreciated by those skilled in the art, the optics to focus the light beam, the lens system to flatten the focal plane to the photosensitive drum, and any fold mirrors to change the direction of the scanned beam are omitted for ease of understanding.

Illustrated below the rotating polygon mirror 10 is a second view of the photosensitive medium 16 or drum 18 as seen from the polygon scanner. As shown by reference number 30 on the photosensitive drum view 18, there is the beginning point of an image of the laser beam 14B on drum 18 immediately after the facet 10B intercepts the light beam 14A and reflects it to the moving photosensitive medium 16 or drum 18.

Referring now to FIG. 1B, there is shown substantially the same arrangement as illustrated in FIG. 1A except the rotating polygon mirror 10 has continued its rotation about axis 24 such that the facet 10B has rotated so that its interception of the laser beam 14A is about to end. As will also be appreciated by those skilled in the art, because of the varying angle the mirror facets present to the intercepted light beam 14A, the reflected light beam 14B will move across the surface of the rotating drum as shown by arrow 25 and dashed line 26 in FIG. 1B.

It will also be appreciated that rotating drum 18 moves substantially orthogonally with respect to the scanning movement of the light beam 14B. However, if the axis of rotation 24 of the rotating mirror was exactly orthogonal to the axis 20 of the rotating photosensitive drum 18, an image of the sweeping or scanning light beam on the photosensitive drum would be recorded at a slight angle. As shown more clearly by the lower view of the photosensitive drum 18, dashed line 26 illustrates that the trajectory of the light beam 14B is itself at a slight angle, whereas the solid line 28 representing the resulting image on the photosensitive drum is not angled but orthogonal to the rotation or movement of the photosensitive medium 16. To accomplish this parallel printed line image 28, the rotating axis 24 of the polygon mirror 10 is typically mounted at a slight tilt with respect to the rotating photosensitive drum 18 so that the amount of vertical travel or distance traveled by the light beam along vertical axis 32 during a sweep or scan across medium 16 is equal to the amount of movement or rotation of the photosensitive medium 16 or drum 18. Alternately, if necessary, this tilt can also be accomplished using a fold mirror that is tilted.

FIG. 1C illustrates that facet 10B of rotating polygon mirror 10 has rotated away from the light beam 14A, and facet 10C has just intercepted the light beam. Thus, the process is repeated for a second image line. Continuous rotation will of course result in each facet of rotating mirror 10 intercepting light beam 14A so as to produce a series of parallel and spaced image lines which when viewed together will form a line of print or other image.

It will be further appreciated by those skilled in the laser printing art, that the rotating polygon mirror is a very precise and expensive part or component of the laser printer that must spin at terrific speeds without undue wear of the bearings even for rather slow speed printers. Therefore, it would be desirable if a less complex flat mirror, such as for example a resonant flat mirror, could be used to replace the complex and heavy polygonal scanning mirror.

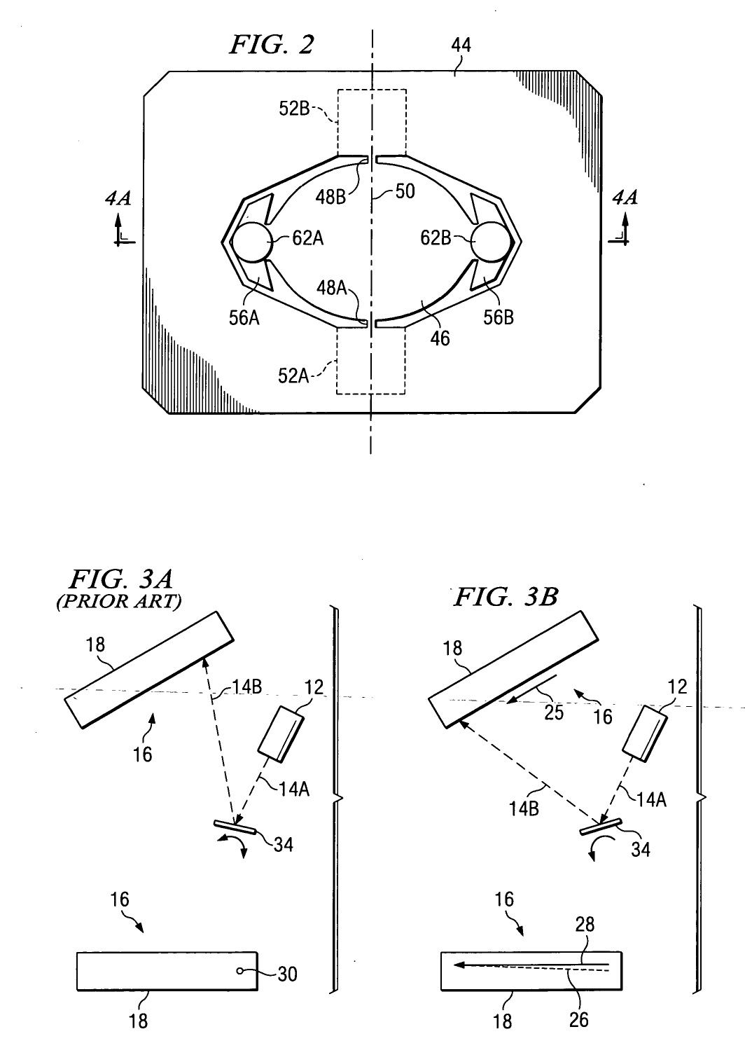

FIG. 2 illustrates a single axis torsional device, where the functional surface of the device is a reflective surface or mirror. However, except where specifically limited by the claims, the invention is also applicable to other functional surfaces, such as for example, a light grating. Other functional surfaces included in the coverage of this invention may not relate to positioning or directing a light beam. The device of FIG. 2 includes a support member 44 supporting an elliptical mirror or reflective surface 46 as the functional surface. The mirror is supported by a single pair of torsional hinges 48A and 48B. Thus, it will be appreciated that if the functional surface, or, according to the present embodiment, mirror portion 46 can be maintained in an oscillation state around axis 50 by a drive source, the mirror can be used to cause a sweeping light beam to repeatedly move across a photosensitive medium. The mechanical motion of the functional surface in the scan axis may be determined by the customers' needs, but, when used as a scanning mirror, will typically be greater than about 5 degrees and may be as great as 45 degrees. It will also be appreciated that an alternate embodiment of a single axis device may not require the support member or frame 44 as shown in FIG. 2. For example, as shown in FIG. 2, the torsional hinges 48A and 48B may simply extend to a pair of hinge anchors 52A and 52B as shown in dotted lines. If the functional surface 46 is a mirror, it may be on the order of 50-400 microns in thickness and is suitably polished on its upper surface to provide a specular or mirror surface.

Further, because of the advantageous material properties of single crystalline silicon, MEMS based devices have a very sharp torsional resonance. The Q of the torsional resonance typically is in the range of 100 to over 1000. This sharp resonance results in a large mechanical amplification of the functional surface motion at a resonance frequency versus a non-resonant frequency. Therefore, it is typically advantageous to pivot or oscillate the functional surface about the primary axis at the resonant frequency. Therefore, if a mirror can be designed to have a resonant frequency equal to the desired scanning frequency, the power needed to maintain the mirror in oscillation can be dramatically reduced.

There are many possible drive mechanisms available to provide the oscillating movement about the scan axis. Resonant drive methods involve applying a small motion at or near the resonant frequency of the device directly to the torsionally hinged functional surface, or alternately to the whole silicon structure, which then excites the functional surface or mirror to resonantly pivot or oscillate about its torsional axis. In inertial resonant type of drive methods a very small motion of the whole silicon structure can excite a very large rotational motion of the device. Suitable inertial resonant drive sources include piezoelectric drives and electrostatic drive circuits. A magnetic resonant drive that applies a resonant magnetic force directly to the torsional hinged functional surface portion has also been found to be especially suitable for a mirror functional surface to generate the resonant oscillation for producing the back and forth beam sweep according to this invention.

Further, by carefully controlling the dimension of hinges 48A and 48B (i.e., width, length and thickness) the device may be manufactured to have a natural resonant frequency, which is substantially the same as the desired oscillating frequency of the functional surface or mirror. Thus, by providing a device with a high resonant frequency, the power loading necessary to provide oscillations may be reduced. This is especially suitable for resonant scanning mirrors.

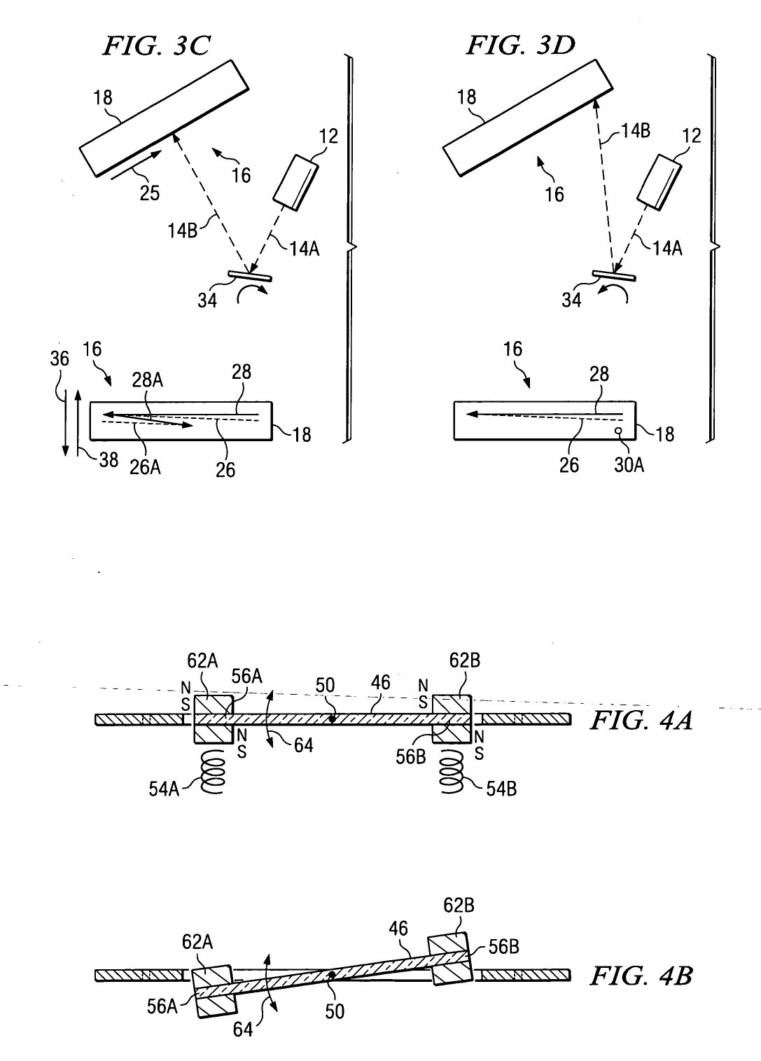

Referring now to FIGS. 3A, 3B, 3C and 3D, there is illustrated a prior art example of a laser printer using a single-axis oscillating mirror to generate the beam sweep. As will be appreciated by those skilled in the art and as illustrated in the following figures, prior art efforts have typically been limited to only using one direction of the oscillating beam sweep because of the non-parallel image lines generated by the return sweep. As shown in FIGS. 3A, 3B, 3C and 3D, the arrangement is substantially the same as shown in FIGS. 1A, 1B and 1C except that the rotating polygon mirror has been replaced with a single oscillating flat mirror 34. As was the case with respect to FIG. 1A, FIG. 3A illustrates the beginning of a beam sweep at point 30 by the single axis mirror 34. Likewise, arrow 25 and dashed line 26 in FIG. 3B illustrate the direction of the beam sweep as mirror 34 substantially completes its scan. Referring to the lower view of the photosensitive drum 18, according to this prior art embodiment, the mirror 34 is mounted at a slight angle such that the beam sweep is synchronized with the movement of the rotating drum 18 so that the distance the medium moves is equal to the vertical distance the light beam moves during a sweep. As was the case for the polygon mirror of FIG. 1B, the slightly angled trajectory as illustrated by dashed line 26 results in a horizontal image line 28 on the moving photosensitive medium 16 or drum 18.

Thus, up to this point, it would appear that the flat surface single torsional axis oscillating mirror 34 should work at least as well as the rotating polygon mirror 10 as discussed with respect to FIGS. 1A, 1B, and IC. However, when the oscillating mirror starts pivoting back in the opposite direction as shown by dashed line 26A in FIG. 3C, with prior art scanning mirror printers, it was necessary to turn the beam off and not print during the return sweep since the vertical movement of the mirror resulting from being mounted at a slight angle and the movement of the moving photosensitive medium 16 or rotating drum 18 were cumulative rather than subtractive. Consequently, if used for printing, the angled trajectory 26 of the return beam combined with movement of the rotating drum 18 would result in a printed image line 28A which is at even a greater angle than what would occur simply due to the movement of the rotating photosensitive drum 18. This, of course, is caused by the fact that as the beam sweep returns, it will be moving in a downward direction rather than an upward direction as indicated by arrow 36, whereas the photosensitive drum movement is in the upward direction indicated by arrow 38. Thus, as stated above, the movement of the drum and the beam trajectory are cumulative. Therefore, for satisfactory printing by a resonant scanning mirror printer according to the prior art, it was understood that the light beam and the printing were typically interrupted and/or stopped during the return trajectory of the scan. Thus, the oscillating mirror 34 was required to complete its reverse scan and then start its forward scan again as indicated at 30A, at which time the modulated laser was again turned on and a second image line printed.

Referring to FIGS. 4A and 4B along with the device assembly of FIG. 2, the assembly may include a pair of serially connected electrical coils 54A and 54B under tabs 56A and 56B respectively to provide the magnetic drive to pivot the device. Thus, by energizing the coils with alternating positive and negative voltage at a selected frequency, the functional surface portion 46 can be made to oscillate at that frequency. It should also be appreciated that if the selected frequency for oscillation is the resonant frequency of the functional surface, the amount of energy necessary to maintain oscillation will be significantly reduced. To facilitate the magnetic drive, the mirror assembly also includes a pair of permanent magnets 62A and 62B mounted on tabs 56A and 56B of the functional surface or mirror portion 46 orthogonal to the axis 50. Permanent magnet sets 62A and 62B symmetrically distribute mass about the axis of rotation 50 to minimize oscillation under shock and vibration. Each permanent magnet 62A, 62B preferably comprises an upper magnet set mounted on the top surface of the functional surface portion 46 using conventional attachment techniques such as adhesive or indium bonding and an aligned lower magnet similarly attached to the lower surface of the functional surface 46 as shown in FIGS. 4A and 4B. There are several possible arrangements of the four sets of magnets which may be used. For example, in FIG. 4A the magnets of each set are arranged serially and have an axial charge such as the north/south pole arrangement illustrated in FIG. 4A.

The middle or neutral position of the functional surface portion 46 of FIG. 2 is shown in FIG. 4A, which is a section taken through the assembly along line 3A-3A of FIG. 2. Rotation of the functional surface portion 46 about axis 50 is shown in FIG. 4B as indicated by arrow 64.

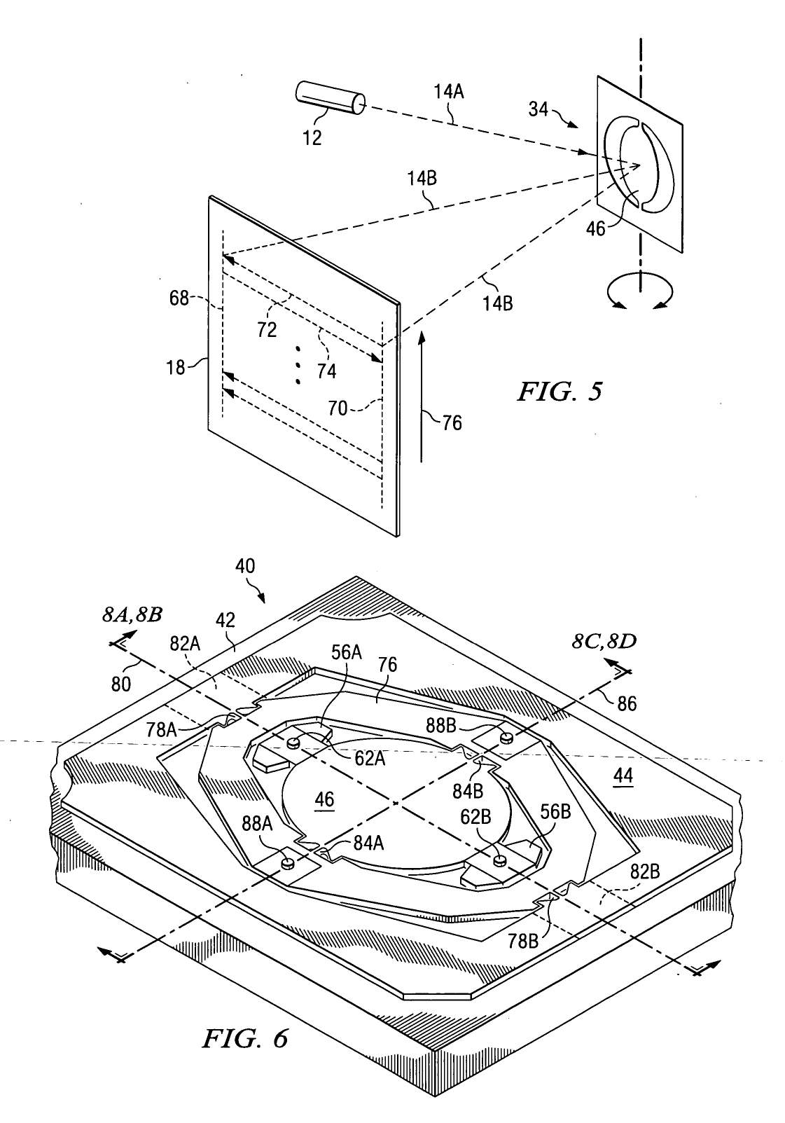

FIG. 5 illustrates a perspective illustration of embodiment of the present invention where the functional surface is a mirror that pivots about a single axis, such as the single axis mirror shown in FIG. 2. The reflecting surface 46 of the single axis mirror 34 receives the light beam 14A from source 12 and provides the right to left and left to right beam sweep 14B between limits 68 and 70 as discussed with respect to FIGS. 3A, 3B, 3C and 3D. This left to right and right to left beam sweep provides the lines 72 and 74 as the medium 18 moves in the direction indicated by arrow 76.

It should also be appreciated that mirrors or other functional surfaces of substantially any shape can be used in the practice of this invention. However, when the teachings of this invention are used to drive mirrors used to provide the scanning beam sweep for a laser printer or display devices, the demand for higher and higher speeds will require a higher and higher resonant oscillation speed of the scanning mirror. It is also important at these very high speeds that the scanning mirror not deform as it sweeps the laser beam across the photosensitive medium during a scan cycle. To this end, a multilayer oscillating mirror driven by electromagnetic forces applied directly to the torsionally hinged mirror portion is believed to be particularly suitable for this invention. The preferred multilayered mirror has a first single crystal silicon layer for the torsional hinges, a second layer for the reflecting surface and a third layer for providing stiffness to the reflective surface to prevent distortion.

Referring now to FIG. 6, there is shown a perspective view of a two-axis functional surface device. According to FIG. 6, the two-axis device is a bi-directional mirror assembly 40 which could be used to provide a bi-directional beam sweep across a photosensitive medium wherein the beam sweep is also adjusted in a direction orthogonal to the oscillations of the mirror to maintain parallel printed image lines produced by a beam sweep in one direction and then in a reverse direction. As shown, the moveable device or mirror assembly 40 is illustrated as being mounted on a support 42, and as being driven along both axes by electromagnetic forces. As was discussed above with respect to single axis pivoting devices, the moveable device assembly 40 may be formed from a substantially planar material and the functional or moving parts may be etched in the planar sheet of material (such as silicon) by techniques similar to those used in semiconductor art. As shown, the functional components include a support member or frame portion 44, similar to the single axis device. However, unlike the single axis device, the support structure of the dual axis device also includes an intermediate gimbals portion 76 along with the functional surface or mirror portion 46. It will be appreciated that the intermediate gimbals portion 76 is hinged to the support member or frame portion 44 at two ends by a pair of torsional hinges 78A and 78B spaced apart and aligned along an axis 80. Except for the pair of hinges 78A and 78B, the intermediate gimbals portion 76 is separated from the frame portion 44. It should also be appreciated that, although support member or frame portion 44 provides an excellent support for mounting the device to support structure 42, it may be desirable to eliminate the frame portion 44 and simply extend the torsional hinges 78A and 78B to anchors 82A and 82B which connect the hinges directly to the support 42 as indicated by dotted lines on FIG. 6.

The inner, centrally disposed functional surface, such as reflective surface or mirror portion 46, is attached to gimbals portion 76 at hinges 84A and 84B along an axis 86 that is orthogonal to or rotated 90° from axis 80. As was discussed with respect to the single axis device of FIG. 2, the reflective surface or mirror portion 46 is also on the order of 50-400 microns in thickness and is suitably polished on its upper surface to provide a specular or mirror surface. If desired, a coating of suitable material can be placed on the mirror portion to enhance its reflectivity for specific radiation wavelengths.

As has also been discussed with respect to single axis devices, there are many combinations of drive mechanisms to pivot and/or oscillate the functional surface. However, to provide movement about the cross scan or orthogonal axis 80, a smaller angular motion is usually sufficient. Therefore, a magnetic drive similar to that discussed with respect to the device of FIG. 2 may be used to produce a controlled orthogonal movement of gimbals portion 76 about the torsional hinges 78A and 78B, and when the functional surface is a mirror, to move the beam sweep to a precise position. Consequently, as shown in FIG. 6, a set of permanent magnet sets 88A and 88B also are associated with the orthogonal movement.

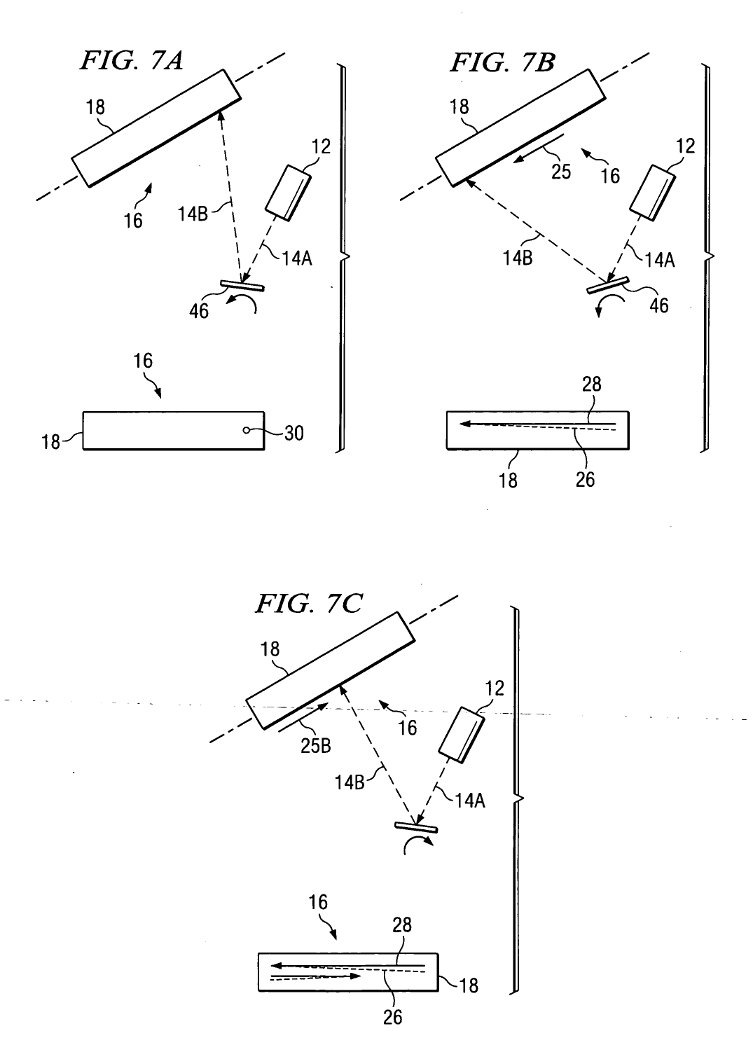

FIGS. 7A, 7B and 7C illustrate the use of a dual axis scanning mirror such as shown in FIG. 6. As can be seen from FIGS. 7A and 7B, the operation of a dual axis scanning mirror assembly 40 as it scans from right to left in the figures is substantially the same as mirror 34 of FIG. 2 pivoting around a single axis as discussed and shown in FIGS. 3A-3D. However, unlike the single axis mirror 34 and as shown in FIG. 7C, the laser (light beam 14B) is not turned off during the return scan, since a return or left to right scan in the FIGS. 7A, 7B and 7C can be continuously modulated during the return scan so as to produce a printed line of images on the moving photosensitive medium 16. The second printed line of images will be parallel to the previous right to left scan, of course, accomplished by slight but precise pivoting of the mirror 46 around axis 80 of the dual axis mirror as was discussed above.

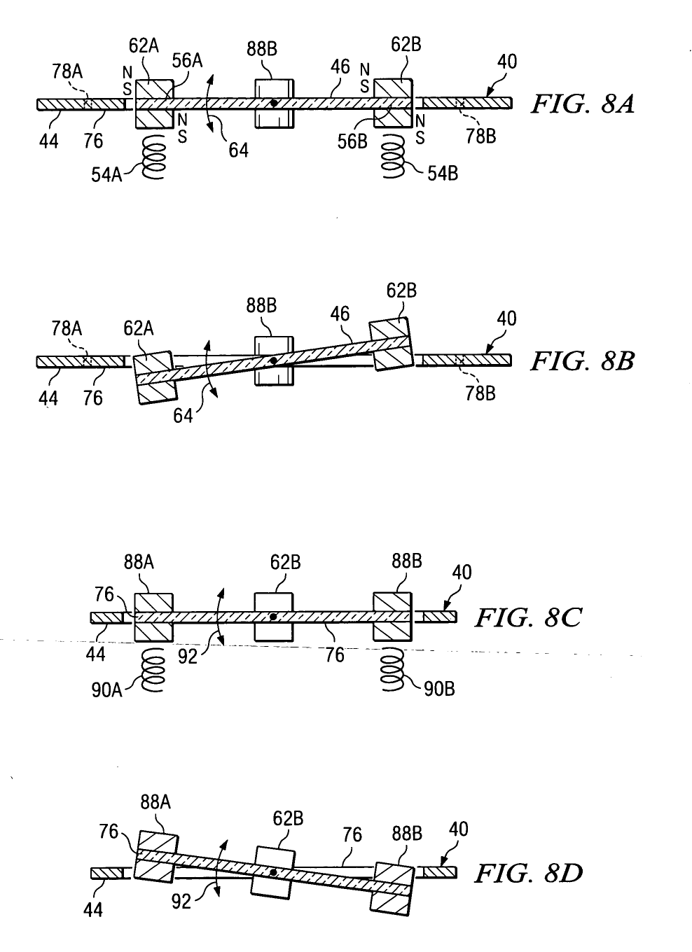

Referring to FIGS. 8A and 8B along with the device of FIG. 6, assembly 40 may typically include a pair of serially connected electrical coils 54A and 54B under tabs 56A and 56B respectively to provide a magnetic drive to oscillate or scan the functional surface as discussed above with respect to the single axis device of FIGS. 4A and 4B. Thus, if the functional surface is a mirror, by energizing the coils with alternating positive and negative voltage at a selected frequency, the functional surface or mirror portion 46 can be made to oscillate at that selected frequency (either resonant or non-resonant) about torsional hinges 84A and 84B. Also as mentioned above, to facilitate the magnetic drive, the assembly 40 also typically includes a first pair of permanent magnets 62A and 62B mounted on tabs 56A and 56B of the functional surface portion 46. Permanent magnet sets 62A and 62B symmetrically distribute mass about the axis of rotation 86 to thereby minimize oscillation under shock and vibration. Further, each permanent magnet 62A, 62B preferably comprises an upper magnet set mounted on the top surface of the functional surface of the assembly 40 using conventional attachment techniques such as adhesive or indium bonding and an aligned lower magnet similarly attached to the lower surface of the assembly 40 as shown in FIGS. 8A and 8B. The magnets of each set of this embodiment are axial charged and are typically arranged serially such as the north/south pole arrangement indicated in FIG. 8A.

Referring now to FIGS. 8C and 8D along with FIG. 6, gimbals portion 76 is mounted to frame portion 44 by means of hinges 78A and 78B. Motion of the gimbals portion 76 about axis 80 as illustrated in FIG. 6 is provided by another pair of serially connected coils 90A and 90B. As has been mentioned, when the functional surface is a drive engine of a printer or visual display, pivoting about axis 80 will provide the discrete vertical motion necessary to maintain consecutive image lines parallel to each other, and is facilitated by permanent magnet sets 88A and 88B.

The middle or neutral position of assembly 40 of FIG. 6 is shown in FIG. 8A, which is a section taken through the assembly along line 4A-4A (or axis 80) of FIG. 6. Rotation of the functional surface portion 46 about axis 86 independent of gimbals portion 76 and/or frame portion 44 is shown in FIG. 8B as indicated by arrow 64. FIG. 8C shows the middle position of the assembly 40, similar to that shown in FIG. 8A, but taken along line 4B-4B (or axis 86) of FIG. 6. Rotation of the gimbals portion 76 (which supports mirror portion 46) about axis 80 independent of frame portion 44 is shown in FIG. 8D as indicated by arrow 92. The above arrangement allows independent rotation of the functional surface portion 46 about the two axes. Thus, when the functional surface is a mirror, this independent rotation of the mirror provides the ability to direct an oscillating beam onto a moving photosensitive medium 16 and still produce parallel image lines.

Further, as discussed above, by carefully controlling the dimension of hinges 84A and 84B (i.e., width, length and thickness) the dual axis device may also be manufactured to have a natural resonant frequency which is substantially the same as the desired oscillating frequency of the device. Further, it is also possible to design the gimbals axis to also have a resonant frequency. Thus, by providing a dual axis device with a resonant frequency for both sets of torsional hinges, the power loading may be reduced or the actuation speed is increased.

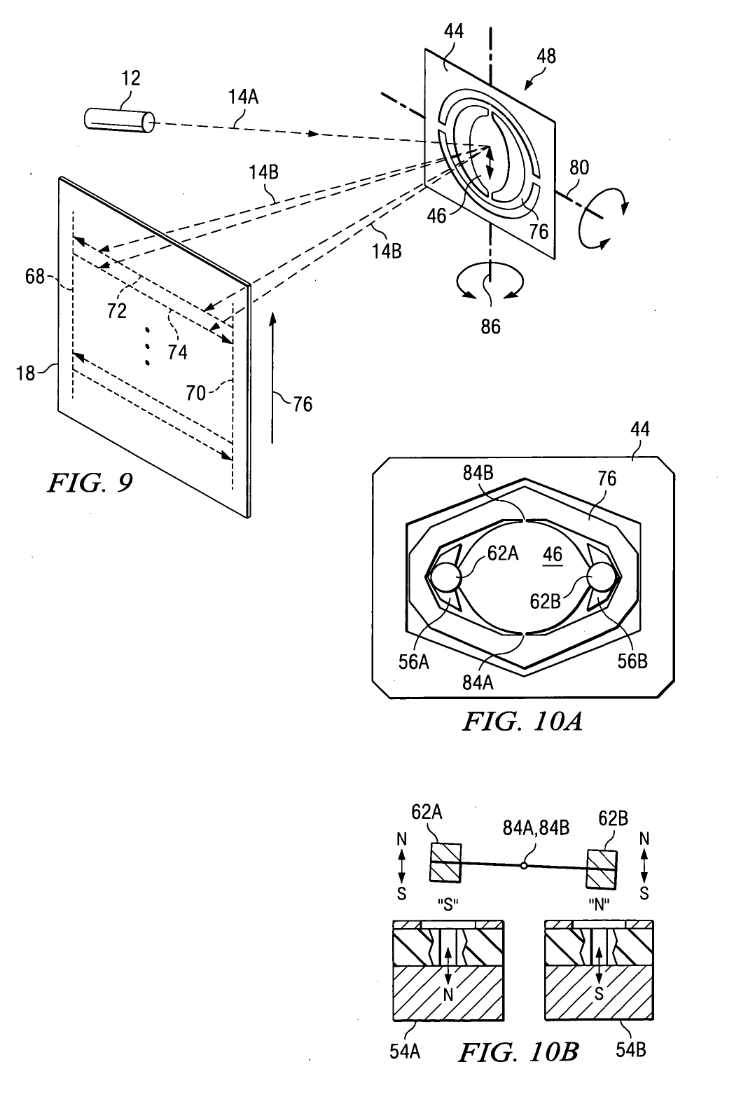

Referring to FIG. 9, there is a perspective illustration of another embodiment of the invention wherein the functional surface is a dual axis mirror of the type shown in FIG. 6. The operation of the dual axis mirror of FIG. 9 is substantially the same as the single axis mirror discussed with respect to FIG. 5, except adjustments may be made to the orthogonal position of the sweeping beam scan by rotation of the mirror assembly around its gimbal axis 80.

From the above discussion, it will be appreciated that it is advantageous to manufacture functional surfaces, and especially scanning mirrors for use as drive engines to have a resonant frequency substantially the same as the desired raster or sweep frequency of a printer or display. As was also discussed, a magnetic drive is an inexpensive, dependable and effective technique for starting and maintaining oscillations of the device at its resonant frequency. Unfortunately, the magnet sets mounted at the tips of the rotating surfaces add to the mass and moment of inertia of the resonant device, which in turn tends to reduce the resonant frequency and pivotal speed of the device. For example, the resonant frequency of one dual axis magnetic device of the type shown in FIG. 6 and having a mirror as the functional surface is about 100 Hz and would be even lower if the mirror size was increased. A speed of 100 Hz simply is not fast enough for many if not most applications for scanning mirrors. Therefore a device with a magnetic drive and increased resonant frequency about one, and preferably both, axes would be advantageous.

Referring now to FIGS. 10A and 10B, along with FIG. 6, there is a further illustration how the coils 54A and 54B interact with the axial charged permanent magnetic sets 62A and 62B to cause movement of the mirror or functional surface 46 about torsional hinges 84A and 84B. In the illustration of FIGS. 10A and 10B, coil 54B receives a voltage having a first polarity that creates a magnetic field having its “N”orth pole at the top of the coil or closest to permanent magnet set 62B whereas the coil 54A is serially connected to coil 54B so that the same voltage polarity creates a magnetic field with the “S”outh pole closest to permanent magnet 62A. Thus, coil 54B attracts magnet set 62B at the same time coil 54A repels magnet set 62A. These forces cause a clockwise rotation of the mirror or reflection surface 46 in the illustration of FIG. 10B. However, if the voltage polarity across coils 54A and 54B is reversed, then coil 54A will attract magnet set 62A and coil 54B will repel magnet set 62B so as to cause the mirror to pivot or rotate in the appropriate direction. Therefore, if the polarity of the voltage across coils 54A and 54B is switched back and forth at a selected frequency, the mirror will oscillate at that frequency. Further, if the selected frequency is the same as the resonant frequency of the mirror, the mirror will be maintained in a resonant oscillating state with minimal energy. However, as discussed, added mass of the magnet sets to the reflective surface results in an unacceptable low resonant frequency and a corresponding slow pivotal rotation for most applications.

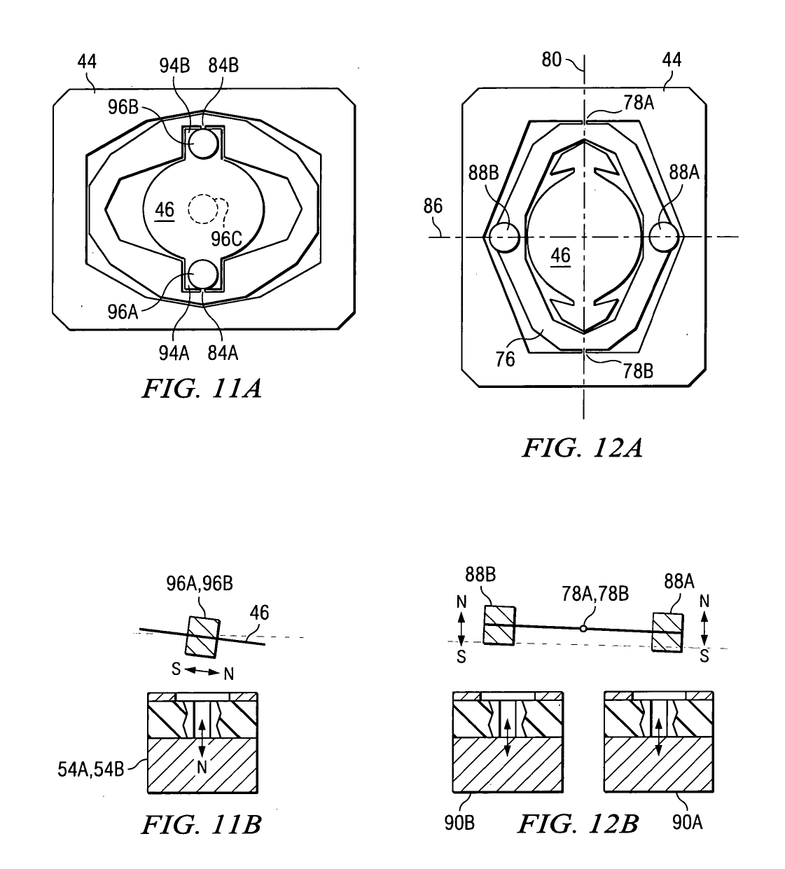

Therefore, referring now to FIGS. 11A and 11B, there is illustrated a pivoting structure and permanent magnet arrangement that significantly reduces the moment of inertia of the functional surface 46 of the device, which increases the resonant frequency and pivotal speed. As shown, the tabs 56A and 56B of FIG. 6 used to mount the permanent magnet sets have been eliminated and, according to one embodiment, replaced by enlarged mounting areas 94A and 94B on the functional surface 46A and adjacent to the torsional hinges 84A and 84B respectively.

Magnet sets 96A and 96B are mounted on enlarged areas 94A and 94B respectively in the same manner as magnet sets 62A and 62B were mounted to tabs 56A and 56B. It is important to note, however, that, as shown in corresponding FIG. 11B, magnet sets 96A and 96B have a diametral charges perpendicular to the axis or rotation rather than the axial charge of magnet sets 62A and 62B. It is, or course, also necessary to relocate the drive coils 54A and 54B so that they are below magnet sets 96A and 96B respectively. Alternatively, a single magnet set indicated by dotted lines 96C located in the center of the functional surface portion 46 and a single drive coil could be used as shown in FIG. 11B.

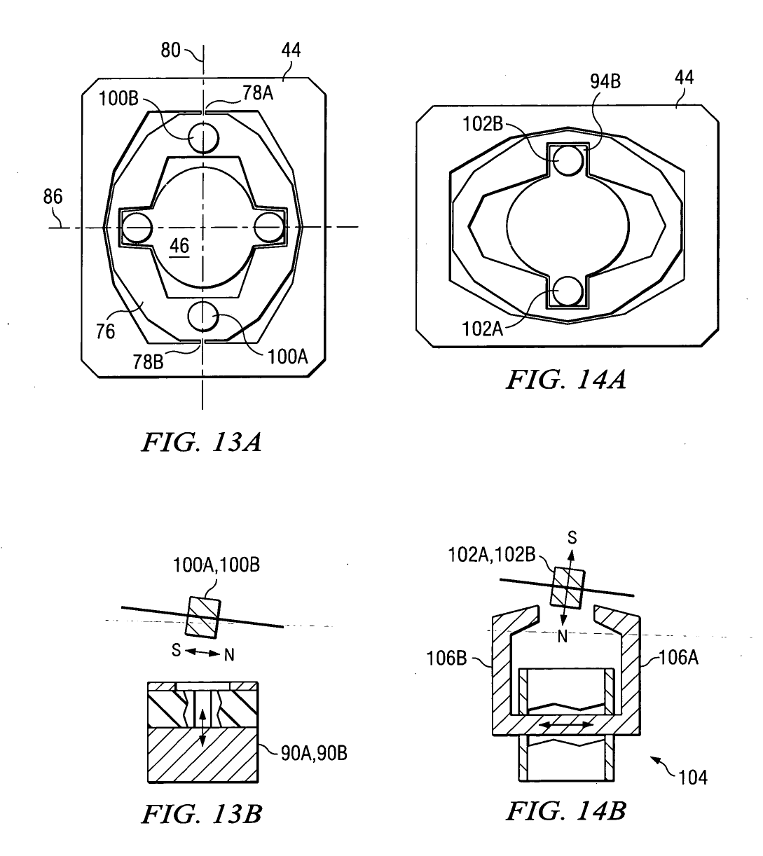

The same approach may also be used to further decrease the mass and moment of inertia of the device by also relocating magnet sets 88A and 88B used to provide controlled orthogonal movement of the mirror structure as shown in FIGS. 12A and 12B. For example, the magnet sets 100A and 100B are relocated from the position on axis 86 so that they are mounted on axis 80 of the gimbals structure 76 as shown in FIG. 13A. The coils 90A and 90B are also relocated to be under magnet sets 100A and 100B. In addition to the significant reduction in the moment of inertia realized by moving the magnet sets onto the axis, it has also been found that the size of the magnet sets 96A and 96B and the magnet sets 100A and 100B can be significantly reduced to further reduce the mass and moment of inertia of the mirror device. The resulting reduction in mass and moment of inertia of the mirror device allows a significant increase in the resonant frequency for both sets of axes. For example, new mirror devices have been fabricated according to this invention with a resonant frequency of over 26 KHz. This high resonant frequency allows for substantially increased pivoting speed at both axes, which is particularly useful for dual axis scanning engines.

FIGS. 14A and 14B show a second magnetic drive arrangement that may be used to drive the resonant sweep motion or the orthogonal motion. Although the drive arrangement is illustrated as a drive using two magnets and two electromagnetic coils to generate the oscillating beam sweep, it will be appreciated that the arrangement could also be used with a single magnet set to generate the oscillating beam sweep, or could be used for the orthogonal drive. As shown, axial charged magnet sets 102A and 102B similar to those shown in FIG. 6, is used instead of diametral charged magnet sets 96A-96B, and 100A-100B. Further, coils shown in FIGS. 10B, 11B, 12B and 13B are replaced by an electro magnet device, such as device 104, having iron or permeable legs 106A and 106B, that extend to each side of the magnet sets 102A and 102B.

It will also be appreciated that the resonant frequency of a single axis device of the type shown in FIG. 2, can also be increased in a manner similar to that discussed above with respect to the dual axis device of FIG. 6. For example, the magnet sets 62A and 62B of FIG. 2 can be relocated from tabs 56A and 56B to enlarged areas at the pivot axis 50. Similarly, diametral charged magnets can be used with the coil structure discussed with respect to FIGS. 11A and 11B or axial charged magnets can be used with the electromagnet arrangement of FIG. 14 with the iron or permeable core to initiate and/or maintain the mirror at its resonant frequency.

The foregoing descriptions of specific embodiments of the present invention have been presented for purposes of illustration and description. They are not intended to be exhaustive or to limit the invention to the precise forms disclosed as many modifications and variations are possible in light of the above teaching. The embodiments were chosen and described in order to best explain the principles of the invention and its practical application to thereby enable others skilled in the art to best utilize the invention and various embodiments with various modifications as are suited to the particular use contemplated. It is intended that the scope of the invention be defined by the claims appended hereto and their equivalents.

1. A scanning device comprising:
a functional surface portion;
support structure pivotally supporting said functional surface portion along a first axis by a pair of torsional hinges having a resonant frequency such that said pivoting of said functional surface portion about said pair of torsional hinges pivots about said first axis;
at least one first magnet located along said first axis;
a first magnetic driver located below and cooperating with said at least one first magnet for causing oscillation about said pair of torsional hinges at a selected frequency.

2. The scanning device of claim 1 wherein said at least one first magnet has a diametral charge perpendicular to the axis of rotation and substantially parallel to said reflecting surface and wherein said first magnetic driver is at least one coil located proximate said one first magnet.

3. The scanning device of claim 2 wherein said at least one first magnet comprises two first magnets, one each located adjacent one each of said first pair of torsional hinges.

4. The scanning device of claim 1 wherein said at least one first magnet has an axial charge and wherein said magnetic driver is an electromagnet having legs extending to each side of its corresponding magnet.

5. The scanning device of claim 1 wherein said at least one first magnet is mounted at the center of said functional surface.

6. The scanning device of claim 1 wherein said support structure comprises a gimbals portion connected to said functional surface along said first axis by said pair of torsional hinges and a support member pivotally supporting said gimbal portion by a second pair of torsional hinges along an axis substantially orthogonal to said first axis, such that said pivoting of said device about said second pair of torsional hinges results in movement substantially orthogonal to said first direction;
at least two second magnets mounted along said second axis and one each located adjacent each one of said second pair of torsional hinges; and
a second magnetic driver cooperating with said at least two second magnets for pivoting said device about said second pair of torsional hinges to provide said orthogonal movement.

7. The scanning device of claim 1 wherein said functional surface is a light grating positioned to intercept a beam of light.

8. The scanning device of claim 1 wherein said functional surface is a reflective surface or mirror positioned to intercept a beam of light.

9. The scanning device of claim 6 wherein said functional surface is a reflective surface or mirror positioned to intercept a beam of light.

10. The scanning device of claim 8 used as the drive engine of a printer.

11. The scanning device of claim 9 used as the drive engine of a printer.

12. The scanning device of claim 9 used as the drive engine of a visual display device.

13. The scanning device of claim 1 wherein said functional surface oscillates at its resonant frequency.

14. The scanning device of claim 9 wherein said functional surface oscillates at its resonant frequency.

15. A printer comprising:
a light source providing a modulated beam of light;
a scanning mirror comprising a reflective surface portion positioned to intercept said beam of light and a support structure pivotally supporting said reflective surface portion along a first axis by a pair of torsional hinges such that said pivoting of said reflective surface portion about said pair of torsional hinges results in said reflected light beam sweeping back and forth in a first direction;
at least one first magnet located along said first axis;
a first magnetic driver located below and cooperating with said at least one first magnet for causing said back and forth sweeping movement of said reflective surface about said pair of torsional hinges;
a moving photosensitive medium having a first dimension and a second dimension orthogonal to said first dimension, and located to receive an image of said reflected light beam as it sweeps back and forth across said moving photosensitive medium along said first dimension, said photosensitive medium moving in a direction along said second dimension such that an image of a subsequent trace of light is spaced orthogonally from a previous trace.

16. The printer of claim 15 wherein said moving photosensitive medium is cylindrical shaped and rotates about an axis through the center of said cylinder.

17. The printer of claim 15 wherein said printer is a bi-directional printer.

18. The printer of claim 15 wherein said at least one first magnet comprises two first magnets, one each located adjacent one each of said first pair of torsional hinges.

19. The printer of claim 15 wherein said at least one first magnet has a diametral charge perpendicular to the axis of rotation and substantially parallel to said reflecting surface and wherein said first magnetic driver is a coil located proximate said one first magnet.

20. The printer of claim 15 wherein said at least one first magnet has an axial charge and wherein said magnetic driver is an electromagnet having legs extending to each side of its corresponding magnet.

21. The printer of claim 15 wherein said back and forth sweeping motion is at the resonant speed of said scanning mirror.

22. The printer of claim 15 wherein said at least one first magnet is located at the center of said reflective surface portion.

23. A bi-directional printer comprising:
a light source providing a modulated beam of light;
a scanning mirror device comprising a reflective surface portion positioned to intercept said beam of light from said light source, said reflective surface pivotally attached along a first axis to a gimbals portion by a first pair of torsional hinges, and said gimbals portion pivotally attached to a support member by another pair of torsional hinges, such that pivoting of said device about said first pair of torsional hinges results in light reflected from said reflective surface sweeping back and forth, and pivoting of said device about said another pair of torsional hinges results in said reflective light moving in a second direction substantially orthogonal to said sweeping beam of light;
at least one first magnet located along said first axis;
a first magnetic driver located below and cooperating with said at least one first magnet for causing said pivoting about said first pair of torsional hinges;
at least two second magnets mounted along said second axis and one each located adjacent each one of said another pair of torsional hinges;
a second magnetic driver cooperating with said at least two second magnets for pivoting said mirror device about said another pair of torsional hinges to provide said orthogonal movement to said sweeping beam of light; and
a moving photosensitive medium having a first dimension and a second dimension orthogonal to said first dimension, and located to receive an image of said reflected light beam as it sweeps or traces across said photosensitive medium along said first dimension as said mirror device pivots about said first pair of said torsional hinges, said photosensitive medium moving in a direction along said second dimension such that an image of a subsequent trace of light is spaced from a previous trace.

24. The bi-directional printer of claim 23 wherein said moving photosensitive medium has cylindrical shape and rotates about an axis through the center of said cylinder.

25. The bi-directional printer of claim 23 wherein said at least one first magnet has a diametral charge perpendicular to the axis of rotation and substantially parallel to said reflecting surface and wherein said first magnetic driver is an air coil located proximate said one first magnet.

26. The bi-directional printer of claim 23 wherein said at least one first magnet has an axial charge and wherein said magnetic driver is an electromagnet having legs extending to each side of its corresponding magnet.

27. The bi-directional printer of claim 23 wherein said at least one first magnet is located at the center of said reflective surface portion.

28. The bi-directional printer of claim 23 wherein said pivoting of said device about said first pair of torsional hinges occurs at the resonant speed of said mirror.

29. The bi-directional printer of claim 23 wherein said at least one first magnet comprises two first magnets locate one each adjacent one each of said first pair of torsional hinges and said first magnetic driver is a pair of coils located one each proximate one each of said two first magnets.

30. The bi-directional printer of claim 23 wherein said at least one first magnet comprises two first magnets and said magnet driver is a pair of magnetic drivers located one each proximate one each of said two first magnets.
